(19) United States
(12) Patent Application Publication
(10) Pub. No.: US 2026/0307044 A1
(43) Pub. Date: Oct. 8, 2026

(54) AMINO ACID BASED CARBON DIOXIDE CAPTURE CATALYZED WITH THREE-DIMENSIONAL GRAPHENE

(71) Applicant: UNIVERSITY OF WYOMING, Laramie, WY (US)

(72) Inventors: Maohong FAN, Ames, IA (US); Sam TOAN, Duluth, MN (US); Lei WANG, Duluth, MN (US); Armistead G. RUSSELL, Atlanta, GA (US)

(21) Appl. No.: 19/481,874

(22) PCT Filed: May 2, 2024
(86) PCT No.: PCT/US2024/027509

§ 371 Date: Nov. 5, 2025

Related U.S. Application Data
(60) Provisional application No. 63/464,307, filed on May 5, 2023.

(51) Int. Cl. B01J 20/20; B01D 53/14; B01J 20/22; B01J 20/30; B01J 20/34

(52) U.S. Cl. CPC B01J 20/205; B01D 53/1425; B01D 53/1475; B01D 53/1493; B01J 20/22; B01J 20/3085; B01J 20/3416; B01J 20/3425; B01J 20/3483; B01D 2252/10; B01D 2252/20494; B01D 2257/504; B01J 2220/46; B01J 2220/4806; B01J 2220/4812

(57) ABSTRACT

Embodiments described herein generally relate to a new class of CO₂-capturing compositions and to processes for making such compositions. In an embodiment, a CO₂-capturing composition includes an amino acid and a three-dimensional graphene. Embodiments described herein also generally relate to processes for CO₂ absorption and CO₂ desorption using the CO₂-capturing compositions. In an embodiment, a process for capturing CO₂ from a gas or gaseous stream is provided that includes introducing a CO₂-containing gas or CO₂-containing gaseous stream with a CO₂-capturing composition.

### GOVERNMENT RIGHTS

The invention was made with government support under Grant No. 1632899 awarded by the National Science Foundation. The government has certain rights in the invention.

### FIELD

Embodiments of the present disclosure generally relate to a new class of CO₂-capturing compositions and to processes for making such compositions. Embodiments of the present disclosure also generally relate to processes for CO₂ absorption and CO₂ desorption using the CO₂-capturing compositions.

### BACKGROUND

Carbon dioxide (CO₂) is a greenhouse gas that significantly contributes to global warming and climate change, owing to the excessive emissions from the combustion of fossil fuels. Direct air capture technology is one of the few options available for the removal of CO₂ from the atmosphere. Benefits of direct air capture as a carbon removal option include its limited land and water footprint and the viability of locating plants on non-arable land close to suitable storage infrastructure, eliminating the need for long-distance CO₂ transport. However, constraints like costs and energy requirements as well as the potential for pollution makes it difficult for general implementation. In addition, conventional sorption-based direct air capture technologies are challenged by their low absorption efficiencies.

Monoethanolamine (MEA) is a commonly used sorbent for CO₂ capture. While MEA captures adequately, MEA has as it is highly corrosive and degrades process and storage infrastructure, leading to costly repairs. Further, MEA requires high amounts of energy to remove the CO₂ and regenerate the MEA. Sorbents with more favorable characteristics than MEA, such as amino acids, are being studied with a goal to find a suitable replacement. Amino acids have the same amine functionality as alkanolamines. Compared to MEA based sorbents, amino acids are characterized by low vapor pressures, higher stability towards oxidative degradation, and environmentally friendly as amino acids are found in nature. However, amino acids themselves have a very slow reaction rate with CO₂ and low CO₂ loading at neutral pH.

There is a need for new CO₂-capturing compositions. There is also a need for new processes for CO₂ absorption and CO₂ desorption.

### SUMMARY

Embodiments described herein generally relate to a new class of CO₂-capturing compositions comprising an amino acid sorbent and a three-dimensional graphene (3DG) as a catalyst. The 3DG may be prepared by a CO₂-to-graphene conversion strategy. In one non-limiting example is provided a CO₂-capturing composition that includes lysine as sorbent and nitrogen-doped (N-doped) 3DG as a catalyst. The CO₂-capturing compositions, which may be porous, may be utilized for a novel, regenerable direct air capture process. Embodiments described herein also generally relate to processes for CO₂ absorption and CO₂ desorption. In some examples, the inventors found that simultaneous enhancements of CO₂ absorption and desorption performance due to enhanced mass transfer of CO₂ from the gas-liquid interface into and out of an amino acid (e.g., lysine) solution as well as addition of both basic and acidic functional groups in the 3DG framework.

In an embodiment is provided a CO₂-capturing composition. The composition includes an amino acid and a 3DG.

In another embodiment is provided a process for forming a CO₂-capturing composition. The process includes heating a mixture comprising three-dimensional graphene (3DG) and an acid to form an acid-treated 3DG. The process further includes reacting the acid-treated 3DG with a nitrogen-containing molecule to form a nitrogen-doped 3DG comprising a basic nitrogen-containing functional group. The process may further include sonically or ultrasonically treating a mixture comprising an amino acid and the nitrogen-doped 3DG to form the CO₂-capturing composition.

In another embodiment is provided a process for capturing CO₂ from a gas or gaseous stream. The process includes introducing a CO₂-containing gas or CO₂-containing gaseous stream with a CO₂-capturing composition comprising an amino acid, a 3DG, and optionally water.

In another embodiment is provided a process for capturing CO₂ from a gas or gaseous stream. The process includes introducing a CO₂-containing gas or CO₂-containing gaseous stream with a CO₂-capturing composition having a first concentration of CO₂ to form a CO₂-capturing composition having a second concentration of CO₂ that is higher than the first concentration of the CO₂, the CO₂-capturing composition comprising an amino acid, a 3DG, and optionally water.

In another embodiment is provided a process for desorption of CO₂. The process includes heating a CO₂-capturing composition having a first concentration of CO₂ to form a CO₂-capturing composition having a second concentration of CO₂ that is lower than the first concentration of the CO₂, the CO₂-capturing composition comprising an amino acid, a 3DG, and optionally water.

In another embodiment is provided a process for desorption of CO₂. The process includes heating a CO₂-capturing composition having a first concentration of CO₂, the CO₂-capturing composition comprising an amino acid, a 3DG, and optionally water. The process further includes separating CO₂ from the CO₂-capturing composition to form a CO₂-capturing composition having a second concentration of CO₂ that is lower than the first concentration of the CO₂.

In another embodiment is provided a process for capturing CO₂ from a gas or gaseous stream. The process includes contacting a CO₂-containing gas or CO₂-containing gaseous stream with a CO₂-capturing composition comprising an amino acid and a three-dimensional graphene (3DG) in an absorption unit to form a CO₂-capturing composition having a first concentration of CO₂. The process further includes heating at least a portion of the CO₂-capturing composition having the first concentration of CO₂ in a desorption unit, and separating CO₂ from the CO₂-capturing composition having the first concentration of CO₂ to form a CO₂-capturing composition having a second concentration of CO₂ that is lower than the first concentration of the CO₂. The process may optionally include regenerating the CO₂-capturing composition from at least a portion of the CO₂-capturing composition having the second concentration of CO₂, recycling at least a portion of the CO₂-capturing composition having the second concentration of CO₂ to the absorption unit, or both.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic diagram of an example experimental setup for direct air capture experiments.

FIG. 2A shows non-limiting X-ray diffraction (XRD) patterns of example solid products before and after water washing of a 3DG catalyst.

FIG. 2B shows non-limiting XRD patterns of an example unfunctionalized (raw) 3DG catalyst, an example acid-treated 3DG catalyst, and an example N-doped 3DG catalyst.

FIG. 3A shows a non-limiting field emission scanning electron microscope (FESEM) image of an example raw 3DG catalyst.

FIG. 3B shows a non-limiting FESEM image of an example acid-treated 3DG catalyst.

FIG. 3C shows a non-limiting FESEM image of an example N-doped 3DG catalyst.

FIG. 3D shows a non-limiting high-resolution transmission electron microscopy (HRTEM) image of an example raw 3DG catalyst.

FIG. 3E shows a non-limiting selected area electron diffraction (SAED) pattern of an example raw 3DG catalyst.

FIG. 3F shows a non-limiting HRTEM image of an example raw 3DG catalyst.

FIG. 3G shows a non-limiting HRTEM image of an example acid-treated 3DG catalyst.

FIG. 3H shows a non-limiting SAED pattern of an example acid-treated 3DG catalyst.

FIG. 3I shows a non-limiting HRTEM image of an example acid-treated 3DG catalyst.

FIG. 3J shows a non-limiting HRTEM image of an example N-doped 3DG catalyst.

FIG. 3K shows a non-limiting SAED pattern of an example N-doped 3DG catalyst.

FIG. 3L shows a non-limiting HRTEM image of an example N-doped 3DG catalyst.

FIG. 4A shows non-limiting data for nitrogen (N₂) adsorption-desorption isotherms for an example raw 3DG catalyst, an example acid-treated 3DG catalyst, and an example N-doped 3DG catalyst.

FIG. 4B shows non-limiting Raman spectra of an example raw 3DG catalyst, an example acid-treated 3DG catalyst, and an example N-doped 3DG catalyst.

FIG. 4C shows non-limiting Fourier transform infrared (FT-IR) spectra of an example raw 3DG catalyst, an example acid-treated 3DG catalyst, and an example N-doped 3DG catalyst.

FIG. 4D shows non-limiting survey X-ray photoelectron spectroscopy (XPS) spectra of an example raw 3DG catalyst, an example acid-treated 3DG catalyst, and an example N-doped 3DG catalyst.

FIG. 4E shows non-limiting high-resolution XPS spectra of the C Is peak of an example N-doped 3DG catalyst.

FIG. 4F shows non-limiting high-resolution XPS spectra of the N Is peak of an example N-doped 3DG catalyst.

FIG. 5A shows a non-limiting X-ray energy-dispersive spectroscopy (XEDS) spectrum and elemental analysis result of an example N-doped 3DG catalyst.

FIG. 5B shows a non-limiting high-angle annular dark-field (HAADF) scanning transmission electron microscopy (STEM) (HAADF-STEM) image of an example N-doped 3DG catalyst.

FIG. 5C shows a non-limiting XEDS mapping image of carbon in an example N-doped 3DG catalyst.

FIG. 5D shows a non-limiting XEDS mapping image of oxygen in an example N-doped 3DG catalyst.

FIG. 5E shows a non-limiting XEDS mapping image of nitrogen in an example N-doped 3DG catalyst.

FIG. 6A shows non-limiting absorption concentration data for the direct air capture of CO₂ by a lysine solution with and without 3DG catalysts.

FIG. 6B shows non-limiting cumulative absorption data for the direct air capture of CO₂ by a lysine solution with and without 3DG catalysts.

FIG. 6C shows non-limiting cumulative desorption data for the direct air capture of CO₂ by a lysine solution with and without 3DG catalysts. The inset shows the increase in desorption amount (%) using an example N-doped 3DG catalyst or an example raw 3DG catalyst compared to without catalyst.

FIG. 6D shows non-limiting desorption rate data for the direct air capture of CO₂ by a lysine solution with and without 3DG catalysts. The inset shows the increase in desorption rate (%) using an example N-doped 3DG catalyst or an example raw 3DG catalyst compared to without catalyst.

FIGS. 7A and 7B show non-limiting data for the acidity and basicity of example 3DG catalysts measured using temperature-programmed desorption of carbon dioxide (CO₂-TPD) and the temperature-programmed desorption of ammonia (NH₃-TPD), respectively.

FIG. 8 shows non-limiting data for the cyclic performance of a composition that includes an example N-doped 3DG catalyst demonstrating the effects of the catalyst on CO₂ absorption amount and CO₂ desorption amount.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to a new class of CO₂-capturing compositions and to processes for making such compositions. As used herein, a “composition” may include component(s) of the composition, reaction product(s) of two or more components of the composition, a remainder balance of remaining starting component(s), or combinations thereof. Embodiments of the present disclosure also generally relate to processes for CO₂ absorption and CO₂ desorption using the CO₂-capturing compositions.

CO₂-capturing compositions (also referred to as compositions for CO₂ capture) can be utilized for capturing CO₂, absorption of CO₂, and/or desorption of CO₂. The CO₂-capturing compositions described herein may be utilized for any suitable carbon capture technique, for example, direct air capture. Unlike conventional sorption-based direct air capture (DAC) technologies which are challenged by low absorption efficiencies resulting from the dilute atmospheric CO₂ concentration (about 400 ppm), the CO₂-capturing compositions described herein are efficient. Further, CO₂-capturing compositions described herein are not corrosive. In addition, in contrast to conventional sorbents, CO₂-capturing compositions described herein have fast reaction rates and high CO₂ loading.

Embodiments of the present disclosure generally relate to CO₂-capturing compositions. CO₂-capturing compositions described herein generally include an amino acid and a three-dimensional graphene (3DG). The CO₂-capturing compositions may further include a solvent. Any suitable solvent such as water may be used for dispersing, solubilizing, and/or suspending at least a portion of the 3DG and/or the amino acid. The CO₂-capturing compositions may be in the form of a solution, suspension, dispersion, or other suitable form.

The amino acid of the CO₂-capturing compositions is utilized as, for example, a sorbent to capture and/or absorb CO₂. Suitable amino acids may include alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, pyrrolysine, or combinations thereof, such as lysine, arginine, histidine, or combinations thereof, such as lysine. Combinations of amino acids, in suitable proportions, may be used.

The 3DG of the CO₂-capturing compositions is utilized as, for example, a catalyst, that catalyzes and/or accelerates the capture, absorption, and desorption of CO₂. Any suitable 3DG catalyst may be utilized. The 3DG catalyst may include an unfunctionalized (or raw) 3DG, an acid-treated 3DG catalyst, a nitrogen-doped (N-doped) 3DG catalyst, or combinations thereof. The 3DG catalyst may be in the form of particles. The 3DG catalyst may be porous or may lack porosity.

In contrast to the unfunctionalized 3DG catalyst, both the acid-treated 3DG catalyst and N-doped 3DG catalyst are chemically functionalized. The acid-treated 3DG catalyst may include one or more acidic functional groups in the 3DG framework. The one or more acidic functional groups of the acid-treated 3DG catalyst may include a carboxylic acid (—CO₂H), a sulfonic acid (—SO₃H), a sulfinic acid (—SO₂H), a thiocarboxylic acid (—COSH, in thione form (—C(S) OH) and/or thiol form (—C(O)SH)), or combinations thereof.

The N-doped 3DG catalyst may include both an acidic functional group and a basic functional group in the 3DG framework. The acidic functional group of the N-doped 3DG catalyst may include a carboxylic acid (—CO₂H), a sulfonic acid (—SO₃H), a sulfinic acid (—SO₂H), a thiocarboxylic acid (—COSH, in thione form (—C(S) OH) and/or thiol form (—C(O)SH)), or combinations thereof. The basic functional group of the N-doped 3DG catalyst may include a nitrogen-containing functional group, such as an amine (—NH₂), an amino (—NH₃), pyrrole, quaternary amine, pyridine, hydroxyl, or combinations thereof, such as pyrrole, quaternary amine, pyridine, or combinations thereof.

Each of the various 3DG catalysts comprises a 3DG framework. The acid-treated 3DG catalyst may further comprise one or more acidic functional groups bonded to the surface of the 3DG framework. The N-doped 3DG catalyst may further comprise one or more acidic functional groups bonded to the surface of the 3DG framework and/or one or more basic functional groups bonded to the surface of the 3DG framework.

As described above, the unfunctionalized 3DG catalyst, the acid-treated 3DG catalyst, and/or the N-doped 3DG catalyst may be porous.

The unfunctionalized 3DG catalyst, the acid-treated 3DG catalyst, and/or the N-doped 3DG catalyst may have an average pore diameter that is from about 0.5 nm to about 50 nm, such as from about 1 nm to about 10 nm, such as from about 1.5 nm to about 5 nm, such as from about 2 to about 4 nm, though other average pore diameters are contemplated. Any of the foregoing numbers may be used singly to describe an open-ended range or in combination to describe a closed-ended range. The average pore diameter is determined by the Barrett, Joyner, and Halenda (BJH) method as described in the Examples Section.

The unfunctionalized 3DG catalyst, the acid-treated 3DG catalyst, and/or the N-doped 3DG catalyst may have a specific surface area that is about 1,500 m²/g or less, such as about 1,000 m²/g or less, about 800 m²/g or less, about 600 m²/g or less, or about 500 m²/g or less, or from about 100 m²/g to about 1,000 m²/g, such as from about 200 m²/g to about 800 m²/g, such as from about 300 m²/g to about 7,000 m²/g, such as from about 400 m²/g to about 6,000 m²/g, though other values are contemplated. Any of the foregoing numbers may be used singly to describe an open-ended range or in combination to describe a closed-ended range. The specific surface area is determined by the Brunauer-Emmett-Teller (BET) method as described in the Examples Section.

The unfunctionalized 3DG catalyst, the acid-treated 3DG catalyst, and/or the N-doped 3DG catalyst may have a micropore area that is about 1,500 m²/g or less, such as about 1,000 m²/g or less, about 800 m²/g or less, about 600 m²/g or less, or about 500 m²/g or less, or from about 100 m²/g to about 1,000 m²/g, such as from about 200 m²/g to about 800 m²/g, such as from about 300 m²/g to about 7,000 m²/g, such as from about 400 m²/g to about 6,000 m²/g, though other values are contemplated. Any of the foregoing numbers may be used singly to describe an open-ended range or in combination to describe a closed-ended range. Micropore area is determined as described in the Examples Section.

The unfunctionalized 3DG catalyst, the acid-treated 3DG catalyst, and/or the N-doped 3DG catalyst may have a micropore area percentage that is about 80% or more, about 100% or less, or combinations thereof, such as about 85% or more, 90% or more, or 95% or more, though other values are contemplated. Any of the foregoing numbers may be used singly to describe an open-ended range or in combination to describe a closed-ended range. Micropore area percentage is determined as described in the Examples Section.

More than one type of 3DG catalyst may be utilized in CO₂-capturing compositions described herein if desired.

Any suitable amount of 3DG catalyst (the unfunctionalized 3DG catalyst, the acid-treated 3DG catalyst, and/or the N-doped 3DG catalyst) may be utilized. The CO₂-capturing compositions may include from about 10 ppm (0.001 wt %) to about 10,000 ppm (1 wt %), such as from about 50 ppm (0.005 wt %) to about 5,000 ppm (0.5 wt %), such as from about 100 ppm (0.01 wt %) to about 1,000 ppm (0.1 wt %), such as from about 200 ppm (0.02 wt %) to about 800 ppm (0.08 wt %), such as from about 300 ppm (0.03 wt %) to about 700 ppm (0.07 wt %), such as from about 400 ppm (0.04 wt %) to about 600 ppm (0.06 wt %), of the 3DG catalyst, based on a total wt % of the composition. Any of the foregoing numbers may be used singly to describe an open-ended range or in combination to describe a closed-ended range. The total wt % of the composition is based on the 3DG catalyst, the amino acid, the optional solvent, and optional additional components. The total wt % of the composition does not exceed 100 wt %.

The CO₂-capturing compositions may include from about 0.1 wt % to about 65.5 wt %, such as from about 1 wt % to about 65 wt %, such as from about 10 wt % to about 30 wt % of the amino acid based on a total wt % of the composition. Any of the foregoing numbers may be used singly to describe an open-ended range or in combination to describe a closed-ended range.

The CO₂-capturing compositions may include from about 34.5 wt % to about 99.9 wt %, such as from about 35 wt % to about 99 wt %, such as from about 10 wt % to about 90 wt %, such as from about 70 wt % to about 90 wt % of the optional solvent based on a total wt % of the composition. Any of the foregoing numbers may be used singly to describe an open-ended range or in combination to describe a closed-ended range.

Embodiments of the present disclosure also relate to processes for forming a CO₂-capturing composition. Operations of processes to form a CO₂-capturing composition may be performed in any suitable vessel. The components may be mixed using suitable devices such as a mechanical stirrer or a magnetic stirrer. Components may be mixed in the presence of a non-reactive gas, such as nitrogen (N₂), argon (Ar), or combinations thereof to degas various components or otherwise remove unwanted gases such as oxygen from the mixture. The processes for forming the CO₂-capturing composition may be carried out in a single vessel or be performed in multiple vessels, or carried out in situ, or carried out continuously.

The unfunctionalized (raw) 3DG catalyst may be formed by a CO₂-to-graphene conversion. The CO₂-to-graphene conversion may be performed by suitable methods. For example, CO₂-to-graphene conversion may include (a) introducing CO₂ into a reactor (which is at a first temperature that is from about 15° C. to about 25° C.) having a metal therein (e.g., Na metal) by either setting a CO₂ pressure of the reactor and/or a flow rate of the CO₂; and (b) forming the unfunctionalized (raw) 3DG catalyst by heating the reactor at a second temperature (with or without flow of the CO₂).

In operation (a) of the CO₂-to-graphene conversion, the pressure of the reactor having the metal therein may be from about 10 psi to about 90 psi, or from about 30 psi to about 70 psi, or from about 40 psi to about 60 psi, or about 50 psi while the reactor is placed at the first temperature. The flow rate of the CO₂ into the reactor having the metal therein may be from about 10 sccm to about 10,000 sccm, or from about 50 sccm to about 500 sccm while the reactor is set at the first temperature. The flow rate of CO₂ depends on the size of the reactor and the mass of the reacting metal. The reaction can be carried out smoothly in a closed vessel under pressure or with a continuous flow of CO₂. The metal utilized in operation (a) of the CO₂-to-graphene conversion may be any suitable metal such as an alkali metal (e.g., sodium (Na)), an alkaline earth metal (e.g., magnesium (Mg)), a transition metal (e.g., copper (Cu)), or other metal (e.g., aluminum (Al)). The metal may be in the form of elemental metal, an oxide, an alloy, or other suitable form.

In operation (b) of the CO₂-to-graphene conversion, the unfunctionalized (raw) 3DG catalyst is formed by heating the reactor at the second temperature that is from about 300° C. to about 900° C., or from about 400° C. to about 800° C., or from about 500° C. to about 700° C., or from about 450° C. to about 650° C., or about 600° C. for a period that is from about 10 hours to about 48 hours, or from about 15 hours to about 36 hours, or from about 18 hours to about 30 hours, or about 24 hours. Although additional gas flow rate regulation and pressure changes are not necessary during operation (b), the gas flow rate may be adjusted or the pressure may be adjusted during the reaction. When gas flow rate or pressure adjustments are made, the microscopic morphology of the reaction product may be better controlled.

Generally the reaction between the metal and CO₂ occurs around 450° C., and once the reaction occurs, it proceeds spontaneously. Subsequent increases in temperature may affect the microscopic morphology of the products. If no reaction occurs, the pressure of the gas satisfies the equation: P=nRT/V where P denotes the pressure of the gas, n denotes the amount of substance in the gas, R denotes the gas constant, T denotes the absolute temperature of the gas, and V denotes the volume of the gas. The pressure of the reactor at 600° C. may not carry a specific value because the pressure of the gas changes during both heating (pressure increase) and chemical reaction (pressure decrease). That is the pressure of the reactor will change from the initial pressure, derived from the gas being consumed after participating in the reaction and the expansion of the remaining gas as it is heated.

Following formation of the unfunctionalized 3DG catalyst by heating, the unfunctionalized 3DG catalyst may be separated from by-products by washing with water and the separated unfunctionalized 3DG catalyst may then be dried.

In one non-limiting example, the CO₂-to-graphene conversion may be performed by loading Na metal into a tube batch reactor, introducing CO₂ into the reactor with the initial pressure of the reactor at about 50 psi at about room temperature, followed by heating the reactor at about 600° C. for about 24 hours.

The acid-treated 3DG catalyst may be formed by heating a mixture comprising the unfunctionalized (raw) 3DG catalyst and an acid to form the acid-treated 3DG catalyst. The acid may include the HNO₃, HCl, H₂SO₄, H₃PO₄, HBr, or combinations thereof, such as HNO₃.

The heating the mixture comprising the unfunctionalized (raw) 3DG catalyst and the acid to form the acid-treated 3DG catalyst is performed by: (a) heating the mixture at a temperature that refluxes the mixture, or at a temperature that is from about 50° C. to about 130° C., or from about 70° C. to about 110° C., or from about 80° C. to about 100° C., or about 90° C.; and/or (b) heating the mixture for a period that is from about 15 minutes to about 4 hours, or from about 30 minutes to about 4 hours, or from about 1 hour to about 3 hours, or about 2 hours.

The acid-treated 3DG catalyst may be purified by suitable means. Purification of the acid-treated 3DG catalyst may be performed by filtering (by, e.g., vacuum or gravity) the mixture comprising the acid-treated 3DG catalyst and the acid to collect solids. The collected solids may then be washed with water until a pH value of neutral is achieved. Then, the collected solids may be dried at a temperature of about 50° C. to about 130° C., or from about 70° C. to about 110° C., or from about 80° C. to about 100° C., or about 90° C. for a period of about 10 hours to about 48 hours, such as from about 15 hours to about 36 hours, such as from about 18 hours to about 30 hours, such as about 24 hours.

The nitrogen-doped (N-doped) 3DG catalyst may be formed by reacting a mixture comprising an acid-treated 3DG catalyst and a nitrogen-containing molecule to form a nitrogen-doped 3DG catalyst comprising a basic nitrogen-containing functional group. The basic nitrogen-containing functional group may include a pyrrole, a quaternary amine, a pyridine, or combinations thereof, among others. The nitrogen-containing molecule may be urea, melamine, thiourea, cyanamide, dicyandiamide, or combinations thereof.

Reacting the acid-treated 3DG catalyst with a nitrogen-containing molecule to form a nitrogen-doped 3DG catalyst may be performed by heating the mixture at a temperature that is from about 110° C. to about 210° C., or from about 130° C. to about 190° C., or from about 150° C. to about 170° C., or about 160° C., and/or for a period that is from about 1 hour to about 5 hours, or from about 2 hours to about 4 hours, or about 3 hours.

Heating of the mixture comprising the acid-treated 3DG catalyst and a nitrogen-containing molecule may be performed in an autoclave. A weight ratio of the acid-treated 3DG catalyst to the nitrogen-containing molecule that is from about 1:10 to about 1:50, or from about 1:20 to about 1:40, or about 1:30.

The N-doped 3DG catalyst may be purified by suitable means. Purification of the N-doped 3DG catalyst may be performed by filtering (by, e.g., vacuum or gravity) the mixture comprising the nitrogen-doped 3DG catalyst and the nitrogen-containing molecule to collect solids. The collected solids may then be washed with water until a pH value of neutral is achieved. Then, the collected solids may be dried at a temperature of about 50° C. to about 130° C., or from about 70° C. to about 110° C., or from about 80° C. to about 100° C., or about 90° C. for a period of about 10 hours to about 48 hours, such as from about 15 hours to about 36 hours, such as from about 18 hours to about 30 hours, such as about 24 hours.

As described above, the CO₂-capturing composition also includes an amino acid(s) and an optional solvent besides the selected 3DG catalyst. Accordingly, the unfunctionalized 3DG catalyst, the acid-treated 3DG catalyst, and/or the N-doped 3DG catalyst formed as described above may then be mixed by suitable methods with one or more amino acids, and optionally a solvent such as water. Mixing may be performed at suitable rotation speeds such as from about 50 revolutions per minute (rpm) to about 1,500 rpm, such as from about 100 rpm to about 1,000 rpm, such as from about 200 rpm to about 800 rpm, such as from about 300 rpm to about 700 rpm, such as from about 400 rpm to about 600 rpm, such as from about 450 rpm to about 550 rpm, such as about 500 rpm. Any of the foregoing numbers can be used singly to describe an open-ended range or in combination to describe a close-ended range. Other rotation speeds are contemplated and may be selected based on the ability to mix the components sufficiently. Additionally or alternatively, the mixture of the 3DG catalyst, amino acid, and optional solvent may be sonicated or ultrasonicated. Vigorous stirring, sonication, or ultrasonication of the mixture results in a more homogeneous distribution of the 3DG catalyst, which avoids agglomeration and allows more surface area to participate in the catalytic reaction.

Two or more components of the CO₂-capturing composition may be subjected to stirring, sonication, or ultrasonication prior to and/or after introducing the third component to the composition. For example, a mixture of the solvent and the amino acid may be subjected to stirring, sonication, or ultrasonication. The stirred, sonicated, or ultrasonicated treated mixture of the solvent and amino acid may be introduced with the 3DG catalyst (e.g., the unfunctionalized 3DG catalyst, the acid-treated 3DG catalyst, and/or the N-doped 3DG catalyst) to form a composition described herein. The resulting mixture may be subjected to sonic treatment or ultrasonic treatment.

Embodiments of the present disclosure also generally relate to processes for capture of CO₂, processes for CO₂ absorption, and processes for CO₂ desorption. Operations of such processes may be performed in any suitable vessel such as an absorption unit where CO₂ is absorbed or captured by the CO₂-capturing composition and/or a desorption unit where the CO₂ is desorbed from the CO₂-capturing composition. The desorption unit and the absorption unit may be the same unit or different units.

A process for capturing CO₂ from a gas or gaseous stream may include introducing a CO₂-containing gas or CO₂-containing gaseous stream with a CO₂-capturing composition described herein. Upon introducing or contacting the CO₂-containing gas or CO₂-containing gaseous stream with the CO₂-capturing composition, a CO₂-enriched CO₂-capturing composition is formed. The resulting CO₂-enriched CO₂-capturing composition has a concentration of CO₂ that is greater than the concentration of CO₂ in the CO₂-capturing composition prior to introduction with the CO₂-containing gas or CO₂-containing gaseous stream.

As used herein, a “CO₂-enriched” composition refers to a composition where the relative amount (or concentration) of CO₂ in a composition after CO₂ absorption (e.g., after introducing or contacting a composition with a CO₂-containing gas or CO₂-containing gaseous stream) is greater than the relative amount (or concentration) of CO₂ in the composition before CO₂ absorption. For example, if a composition includes 1 mmol CO₂/mol sorbent before CO₂ absorption, the composition formed after the CO₂ absorption would include greater than 1 mmol CO₂/mol sorbent.

The CO₂-capturing composition may be used to capture CO₂ from any suitable CO₂-containing gas or CO₂-containing gaseous stream. For example, the CO₂-capturing composition may be used to remove CO₂ present in air.

The amount of CO₂ in the CO₂-containing gas or CO₂-containing gaseous stream may be any suitable amount such as greater than 0 ppm, or about 10,000 ppm or less, or combinations thereof, such as from about 1 ppm to about 10,000 ppm, or from about 1 ppm to about 5,000 ppm, or from about 1 ppm to about 2,000 ppm, or from about 1 ppm to about 1,500 ppm, or from about 1 ppm to about 1,000 ppm, or from about 1 ppm to about 500 ppm, or from about 1 ppm to about 400 ppm, or from about 1 ppm to about 300 ppm, or from about 1 ppm to about 200 ppm, or from about 1 ppm to about 100 ppm CO₂. Any of the foregoing numbers may be used in combination to describe a closed-ended range.

Besides CO₂, the CO₂-containing gas or CO₂-containing gaseous stream may further include one or more other gases such as N₂ and/or O₂ in any suitable concentrations. The CO₂-containing gas or CO₂-containing gaseous stream may include air.

During the CO₂ capturing process (or CO₂ absorption process), the vessel containing the CO₂-capturing composition may be placed at any suitable pressure such as from about 0.7 atm (about 10.3 psi) to about 1.3 atm (about 19.1 psi), such as from about 0.8 atm (about 11.8 psi) to about 1.2 atm (about 17.6 psi), such as from about 0.9 atm (about 13.2 psi) to about 1.1 atm (about 16.2 psi), such as about 1 atm (about 14.7 psi). Any of the foregoing numbers may be used in combination to describe a closed-ended range. The temperature during the CO₂ capturing process may be set at a temperature that is from about 5° C. to about 40° C., such as from about 10° C. to about 35° C., such as from about 15° C. to about 30° C., such as from about 20° C. to about 25° C., or from about 15° C. to about 25° C. Any of the foregoing numbers may be used in combination to describe a closed-ended range.

The process for capturing CO₂ may be achieved using suitable equipment and suitable CO₂-capturing conditions. The process for capturing CO₂ may be practiced by passing a CO₂-containing gas or CO₂-containing gaseous stream through the CO₂-capturing composition. For example, the CO₂-capturing process may be practiced by contacting the CO₂-containing gas or CO₂-containing gaseous stream with droplets of the CO₂-capturing composition.

Capture of CO₂ from a CO₂-containing gas or CO₂-containing gaseous stream by CO₂-capturing compositions described herein may be performed by direct addition of CO₂-capturing composition to a flowing CO₂-containing gas/gaseous stream or in a gas-liquid contactor or scrubber, such as a bubble column, packed column, or tray column; or by other suitable means to increase gas/liquid contact time and/or surface area. CO₂ in liquid streams may be sparged or stripped into a gas phase, and that gas phase sent to a gas-liquid contactor, or direct liquid-liquid contact may be used. The spent reaction liquid, comprising reacted CO₂-capturing composition, may be removed and optionally replaced with fresh CO₂-capturing composition all at once batchwise, or the spent reaction liquid may be continuously blown down to a wastewater facility or otherwise discarded and replenished with fresh CO₂-capturing composition at a controlled rate.

A process for desorption of CO₂ may include heating a CO₂-capturing composition described herein having a first concentration of CO₂ (e.g., a CO₂-enriched composition). Upon heating, the CO₂ is desorbed, removed, or otherwise separated from the CO₂-capturing composition having the first concentration of CO₂ to form a CO₂-capturing composition having a second concentration of CO₂ (a CO₂-depleted composition) that is lower than the first concentration of the CO₂. The CO₂-depleted composition may still contain an amount of CO₂.

As used herein, a “CO₂-depleted” composition refers to a composition where the relative amount (or concentration) of CO₂ in a composition after CO₂ desorption (e.g., after removing CO₂) is less than the relative amount (or concentration) of CO₂ in the composition before CO₂ desorption. For example, if a composition includes 30 mmol CO₂/mol sorbent before CO₂ desorption, the composition formed after CO₂ desorption would include less than 30 mmol CO₂/mol sorbent.

Heating the CO₂-capturing composition during the CO₂ desorption process may be performed at a heating temperature that is less than a boiling point of the solvent, such as about 15° C. or more, about 100° C. or less, or combinations thereof, such as from about 25° C. to about 95° C., such as from about 50° C. to about 95° C., such as from about 60° C. to about 80° C., or from about 70° C. to about 90° C., or from about 85° C. to about 90° C. Any of the foregoing numbers may be used in combination to describe a closed-ended range. During the heating operation of the CO₂ desorption process, the vessel containing the CO₂-capturing composition may be placed at any suitable pressure such as from about 0.7 atm (about 10.3 psi) to about 1.3 atm (about 19.1 psi), such as from about 0.8 atm (about 11.8 psi) to about 1.2 atm (about 17.6 psi), such as from about 0.9 atm (about 13.2 psi) to about 1.1 atm (about 16.2 psi), such as about 1 atm (about 14.7 psi). Any of the foregoing numbers may be used in combination to describe a closed-ended range.

While heating the CO₂-capturing composition during the CO₂ desorption process, a gas such as N₂ may be flowed into the vessel containing the CO₂-capturing composition. The N₂ gas may be flowed at a rate of about 100 mL/min to about 1,000 mL/min, such as from about 200 mL/min to about 900 mL/min, such as from about 300 mL/min to about 800 mL/min, such as from about 400 mL/min to about 600 mL/min, such as about 500 mL/min. Any of the foregoing numbers may be used in combination to describe a closed-ended range.

Upon desorbing, removing, or otherwise separating CO₂ from the CO₂-enriched CO₂-capturing composition to form the CO₂-depleted CO₂-capturing composition, the CO₂-depleted CO₂-capturing composition may be reused for further CO₂-capturing. Additionally, or alternatively, a CO₂-capturing composition described herein may be regenerated from at least a portion of the CO₂-depleted composition. Additionally, or alternatively, at least a portion of the CO₂-depleted CO₂-capturing composition and/or regenerated CO₂-capturing composition may be recycled to the absorption unit.

Unlike conventional MEA which requires high amounts of energy to remove the CO₂ and regenerate the MEA, CO₂ can be removed/desorbed from CO₂-capturing compositions described herein at significant lower temperatures (less energy) to regenerate the CO₂-capturing compositions.

Processes described herein may be utilized for any suitable carbon capture technique, for example, direct air capture.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (e.g. amounts, dimensions, etc.) but some experimental errors and deviations should be accounted for.

### EXAMPLES

Examples of CO₂-capturing compositions were made using processes and compositions of the disclosure, and examples of processes for CO₂ capture, CO₂ absorption, and CO₂ desorption were performed using processes and composition of the disclosure. The Test Methods describes methods of characterizing compositions and processes. Example 1 describes the preparation of the different 3DG catalysts and the CO₂-capturing compositions. Examples 2 and 3 describe the experimental setup for the DAC experiments using the CO₂-capturing compositions and the processes for CO₂ absorption and CO₂ desorption using the CO₂-capturing compositions. Non-limiting results and discussion is then provided.

### Test Methods

X-ray diffraction (XRD) data was obtained using an X-ray diffractometer (XRD, Bruker-D8, Germany) with Cu Kα radiation (λ=1.5406 Å).

Specific surface area (SSA) was measured using a Micromeritics ASAP 2020 surface area measurement analyzer, which measured N₂ adsorption and desorption isotherms at a liquid-nitrogen temperature (77 K). Prior to the N₂ adsorption and desorption measurements, the sample was degassed at a temperature of 250° C.

Raman analysis was performed using a LabRAM HR Evolution Raman microscope with a 532 nm laser.

Fourier-transform infrared spectrometry (FT-IR, Nicolet 6700, Thermo Fisher Scientific, USA) was utilized to detect functional groups in each sample.

X-ray photoelectron spectroscopy (XPS, Multilab 2000, UK) was carried out to determine the surface elemental compositions and chemical states of the samples, using the C 1s peak at 284.8 eV as a reference.

Morphology and elemental distribution were determined by field emission scanning electron microscope (FESEM) and X-ray energy-dispersive spectrometry (XEDS) with a ZEISS SUPRA 55VP scanning electron microscope (SEM), equipped with a BRUKER X Flash Detector 5010.

High-resolution transmission electron microscopy (HRTEM) was obtained by using an FEI Tecnai G2 F20 TEM, equipped with a field emission gun and operated at 200 kV.

Pore features and adsorption properties were measured using CO₂/NH₃ temperature-programmed desorption (TPD) curves. The temperature-programmed desorption of ammonia (NH₃-TPD) was used to test the amount and strength of the acid sites of the various as-prepared 3DG catalysts using a TP-5080 chemisorption instrument. The various as-prepared 3DG catalysts (100 mg) were pre-treated at 120° C. under a flow of helium gas (30 ml/min) for 120 minutes and then cooled down to 35° C. Then NH₃ was introduced into the flow system for 60 minutes. After purging with helium flow at 35° C. for 60 minutes to remove the physically-adsorbed NH₃, the sample was heated at a rate of 10° C./min up to 900° C. and the data was recorded by a thermal conductivity detector (TCD). The surface basicity of the various as-prepared 3DG catalysts was determined by the CO₂-TPD technique, and the measurement process was the same as that for NH₃-TPD, except for the replacement of NH₃ with CO₂.

### Example 1. Preparation of Example 3DG Catalysts

### 1.A. Unfunctionalized (Raw) 3DG Catalyst

The unfunctionalized (raw) 3DG catalyst was prepared by a CO₂-to-graphene conversion. Na metal (about 5 g) was loaded into a ceramic tube batch reactor and CO₂ was introduced into the reactor with the initial pressure of the reactor at 50 psi at room temperature, followed by the reactor being heated to about 600° C. for about 24 hours. The obtained unfunctionalized 3DG catalyst was separated from by-products by washing with deionized (DI) water washing and drying. These samples were named or “raw 3DG” or “unfunctionalized 3DG”.

### 1.B. Acid-treated 3DG Catalyst

A functionalized (raw) 3DG catalyst (about 0.5 g) was refluxed in about 20 mL nitric acid (HNO₃, AR 65-68%) at 90° C. for 2 hours. After cooling, solid products were collected by vacuum filtration and washed with DI water until the pH value returned to neutral, and then dried at 90° C. for 24 hours to provide the acid-treated 3DG catalyst. These samples were named as “acid-treated 3DG”.

### 1.C. Nitrogen-doped 3DG Catalyst

An acid-treated 3DG catalyst (0.5 g) was stirred in 80 mL aqueous urea (weight ratio of 1:30 acid-treated 3DG to urea) for 30 min. This mixture was treated hydrothermally by sealing it in a 100 mL Teflon-lined autoclave and maintained at 160° C. for 3 hours. After the reactor cooled to room temperature, the solid products were washed with DI water until pH returned to neutral, and then dried at 90° C. for 24 hours to provide the N-doped 2DG catalyst. These samples were named as “N-doped 3DG”.

In contrast to the raw 3DG catalyst which is unfunctionalized, both the acid-treated 3DG catalyst and N-doped 3DG catalyst are functionalized. The acid-treated 3DG catalyst includes acidic functional groups in the 3DG framework. The N-doped 3DG catalyst includes both acidic and basic functional groups in the 3DG framework.

### 1.D. CO₂-Capturing Compositions

0.02 g of an example 3DG catalyst—example raw 3DG catalyst, example acid-treated 3DG catalyst, or example N-doped 3DG catalyst—was added to an aqueous lysine solution (0.25 M, 40 mL). The mixture was dispersed with ultrasonic agitation for 5 min. The resulting dispersion/solution may be used for CO₂ capture.

### Example 2. Experimental Setup for DAC of CO₂

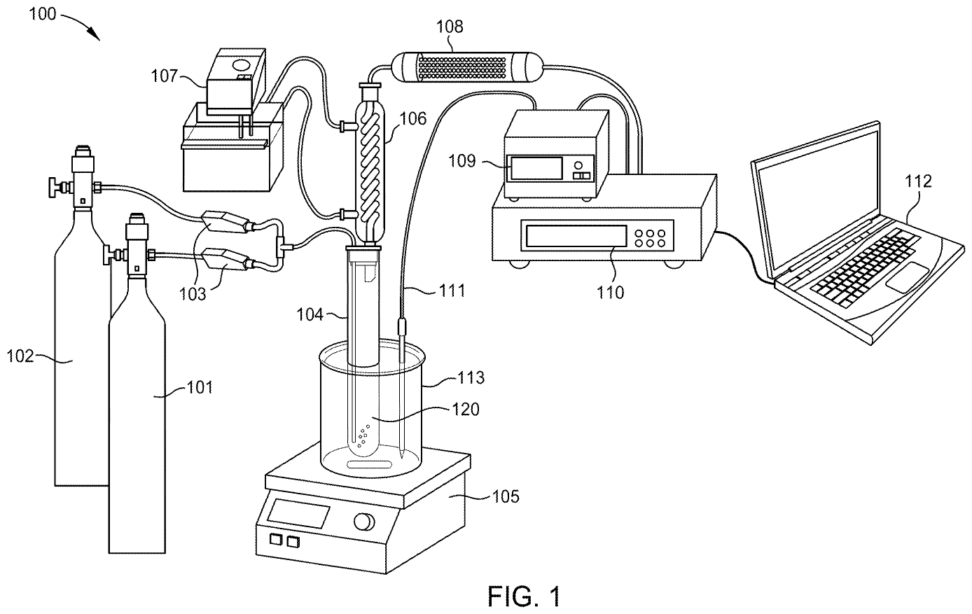

Studies on CO₂ capture, absorption, and desorption were carried out using apparatus 100, an experimental setup, depicted schematically in FIG. 1. The apparatus 100 for CO₂ capture shown in FIG. 1 included the following elements: an air cylinder 101 (having an amount of CO₂), a nitrogen (N₂) cylinder 102, mass flow controller(s) 103, a 100 mL tube reactor 104, a heater/magnetic stirrer 105, a condenser 106, a refrigerated bath circulator 107, a desiccator 108, a paperless recorder 109 (datalogger), a gas analyzer 110, a thermocouple 111, a computer 112, and a water bath 113.

The following gases from Praxair were used for every experimental run: 100% nitrogen (N₂); and air with about 400 ppm CO₂. The mass flow controllers 103 utilized for the experiments were red-y smart series mass flow controllers. The mass flow controllers 103 were used to control the flow rate of the inlet gases into the solution comprising the composition 120 for CO₂ capture and/or gas analyzer 110. The gas analyzer 110 utilized for the experiments was a CAI ZPA gas analyzer, and is used to measure the concentration of CO₂ in the gas stream, and it is connected to a Monarch datalogger (paperless recorder 109) that records and stores the data for further analysis. The thermocouple 111 was also connected to the paperless recorder 9 to record the temperature data. The refrigerated bath circulator 107 is a cold-water bath controlled by a Thermo Neslab Digital Plus RTE-17 chiller, and this cold water bath runs through the condenser 106, keeping it at about 5° C. throughout the experiment.

### Example 3. Direct Air Capture Process of Absorption and Desorption of CO₂

A CO₂-capturing composition (as a dispersion/solution) as prepared above, or a control without catalyst, are individually transferred into a 100 mL tube reactor 104. Tests were performed with the various 3DG catalysts, labeled as example raw 3DG, example acid-treated 3DG, example N-doped 3DG, and without catalyst (without 3DG).

The first stage of the experiment involves CO₂ capture/absorption at room temperature (about 22° C.), and a pressure of 1 atm. The gas analyzer 110 and datalogger (paperless recorder 109) were purged by N₂ prior to absorption. During absorption, air gas with 400 ppm CO₂ from the air cylinder 101 flows through a mass flow controller 103 at a flow rate of 500 mL/min and into the vertical reaction tube containing the 40 mL solution (comprising the CO₂-capturing composition or the control) where the CO₂ is absorbed. The air gas then flows through the condenser 106, and through desiccator 108 before reaching the gas analyzer 110 where the unabsorbed CO₂ concentration in the effluent gas is measured for a total experiment time of 4.5 hours.

The second stage of the experiment involves CO₂ desorption at 1 atm. The vertical reaction tube (the reactor 104) is placed in a water bath 113 and the water bath is placed on the heater. The thermocouple 111 is placed into the water bath 113 to monitor the temperature throughout the experiment, and the heater/magnetic stirrer 105 is set to 500 rpm. The gas analyzer 110 and datalogger (paperless recorder 109) are purged by N₂ from N₂ cylinder 102 before desorption. N₂ flows through the CO₂-capturing composition at 500 mL/min for 1 hour. During this time, the solution (comprising the CO₂-capturing composition or the control) is heated to a temperature of 70° C., and CO₂ is desorbed and measured in the effluent gas by the gas analyzer 110.

### Non-Limiting Results and Discussion

### Analysis of the 3DG Materials

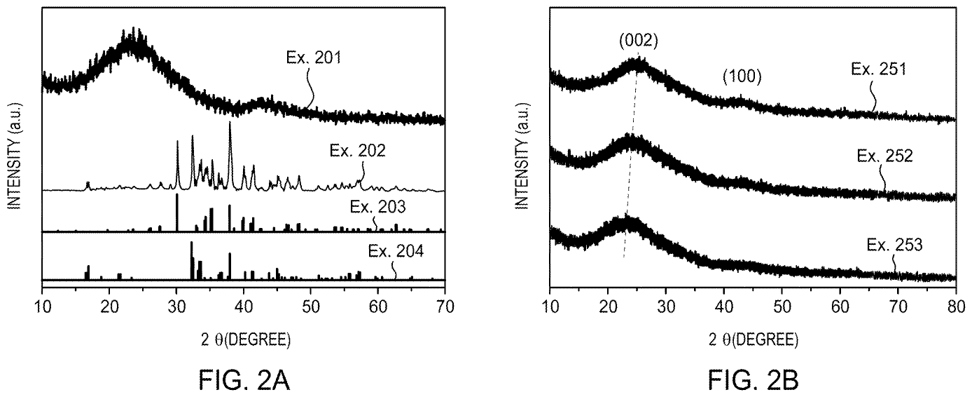

XRD measurements of the products from the CO₂-to-graphene conversion (e.g., the Na metal and CO₂ reaction) are shown in FIG. 2A and the by-products were determined to include Na₂CO₃. The product mixture from the CO₂-to-graphene conversion, which contains the unfunctionalized 3DG, was washed with water.

In FIG. 2A, Ex. 201 refers to the water-washed sample, Ex. 202 refers to the sample before water washing, Ex. 203 refers to Na₂CO₃, and Ex. 204 refers to Na₂CO₃·H₂O. Additionally, the production of carbon nanowalls from the reaction was obtained by removing the by-products using DI water. As shown in FIG. 2A, the water-washed sample (Ex. 201) exhibited relatively strong diffraction peaks at 20 of about 23° and about 43°, which are associated with the (002) diffraction line from hexagonal graphite (JCPDS No: #65-6212). The corresponding d-spacing of the unfunctionalized 3DG was determined to be about 3.72 Å, a larger value than the interlayer space of graphite (3.35 Å). This result indicated that the unfunctionalized 3DG carbon material possesses a layered structure. Therefore, it can be concluded that the reaction between Na metal and CO₂ produced unfunctionalized (raw) 3DG at about 600° C. as shown in Equation 1:

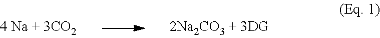

FIG. 2B shows the XRD results of an example raw 3DG (Ex. 253), an example acid-treated 3DG (Ex. 252), and an example N-doped 3DG (Ex. 251). All peaks may be indexed to hexagonal graphite and no crystalline impurities were observed. The peak position of (002) plane in the XRD pattern of the example acid-treated 3DG (Ex. 252) and the example N-doped 3DG (Ex. 251) showed a right shift with respect to that of the example raw 3DG (Ex. 253). While not wishing to be bound by any particular theory, the right shift may be attributed to the introduction of more functional groups.

The morphology of the different 3DG carbon materials were evaluated by FESEM, HRTEM, and SAED.

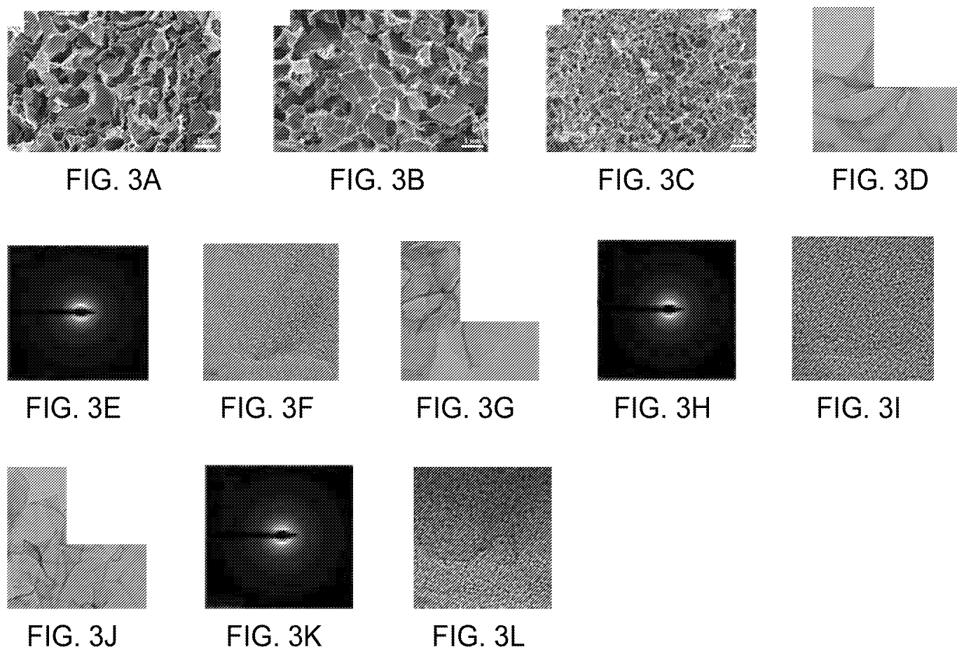

The FESEM image of the example raw 3DG (FIG. 3A) indicated that the as-synthesized graphene sheets possess a 3D honeycomb shape. The 3D honeycomb-structure of the example raw 3DG was supported by the HRTEM images of FIGS. 3D and 3F. As shown in FIG. 3D, the example raw 3DG was determined to be composed of disordered graphitic domains with stacked-graphene sheets (FIG. 3D). Further, the high-magnification HRTEM image (FIG. 3F) of the example raw 3DG shows the existence of a well-defined few layered graphene structure. The overall layer number of the example raw 3DG was observed to be approximately 4-6. This result confirmed that the as-synthesized material is a 3D graphene material, because a carbon layer containing 10 or less graphene sheets is generally defined as a graphene material. The disordered structure of the example raw 3DG was further supported by SAED patterns (FIG. 3E), which showed a polycrystalline ring pattern. Different from spot patterns of flat graphene sheets, a ring diffraction pattern arises from scrolled or folded graphene sheets.

FIG. 3B shows the FESEM micrograph of the example acid-treated 3DG formed from after the heat reflow of the example raw 3DG with nitric acid (the example acid-treated 3DG). As shown, some small carbon flakes in the example 3D-graphene were dissolved and the microstructures of example acid-treated 3DG were flat with slightly restacked nanosheets. As shown in FIG. 3C, after the hydrothermal treatment with urea to form the example N-doped 3DG, the 3DG still has an interconnected hierarchical porous structure, but the graphene sheet layers exhibit significant agglomeration and stacking. FIGS. 3G-3L show that example acid-treated 3DG and the example N-doped 3DG have the same (or similar) microstructure of graphene sheets compared to the example raw 3DG. Under the conditions tested, acid treatment and nitrogen doping did not change the thickness and disordered structure of graphene sheet layers.

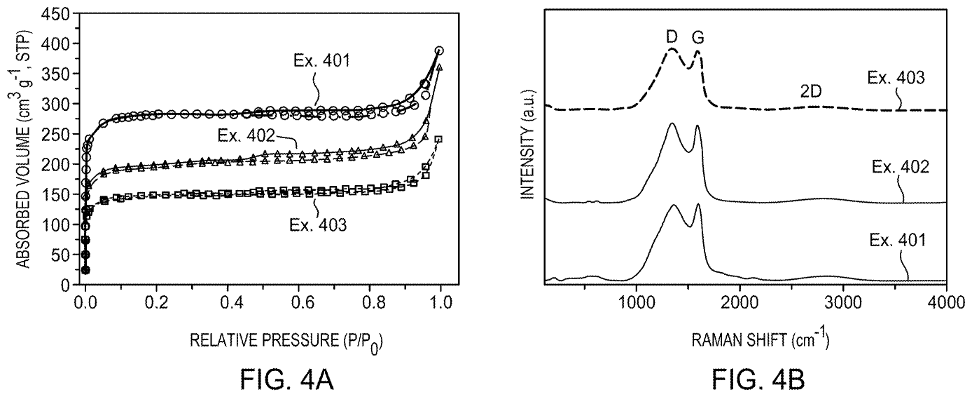

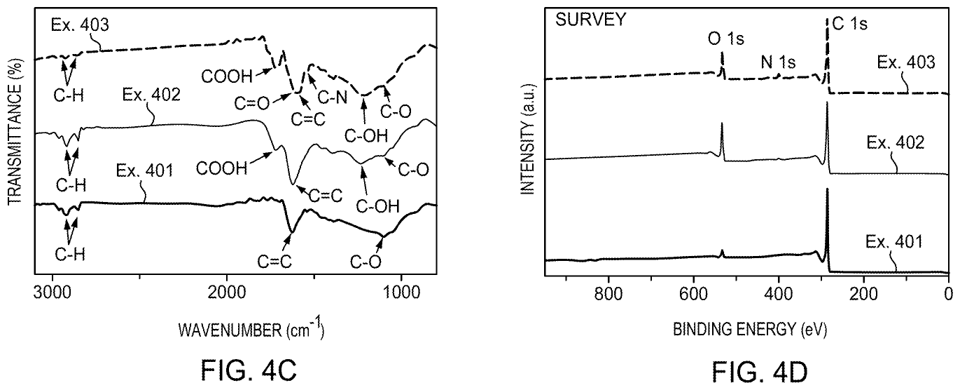

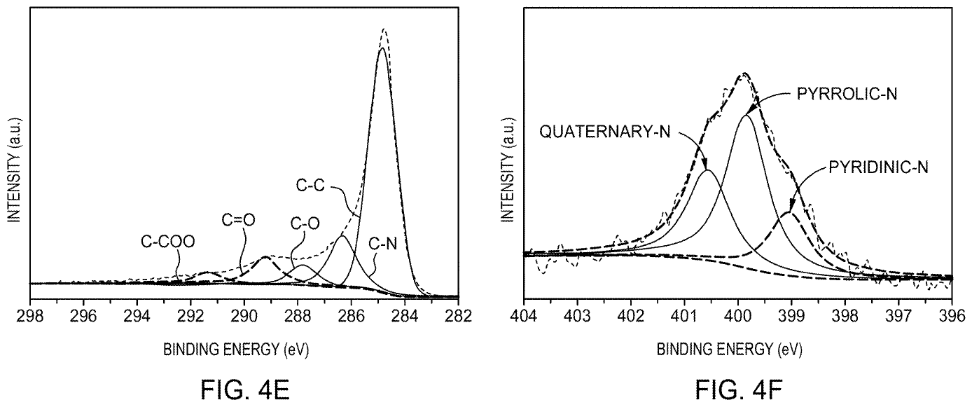

N₂ adsorption-desorption isotherms at 77 K were conducted to determine the specific surface area and porous structure of the example raw 3DG (Ex. 401), the example acid-treated 3DG (Ex. 402), and the example N-doped 3DG (Ex. 403). Results are shown in FIG. 4A. The adsorption-desorption curves were fitted with a type-IV isotherm with an H3 hysteresis loop, which indicated a microporous structure. Table 1A shows selected properties of the as-synthesized example 3DGs that were calculated from the isotherms.

TABLE 1A
Specific surface areas and pore structures
of the as-synthesized example 3DGs

| | Raw | Acid-treated | N-doped |
|---|---|---|---|
| Property | 3DG | 3DG | 3DG |
| BET specific surface area, m²/g | 831.98 | 583.96 | 453.89 |
| Micropore area, m²/g | 823.15 | 538.39 | 416.69 |
| Micropore area percentage, % | 98.9 | 92.2 | 91.8 |
| BJH Pore diameter, nm | 2.64 | 3.13 | 3.27 |

The example raw 3DG had a BET specific surface area of about 831.98 m²/g and a micropore area of about 823.15 m²/g. These values were higher than those of the example acid-treated 3DG (BET specific surface area of about 583.96 m²/g; micropore area of about 538.39 m²/g), and those of the example N-doped 3DG (BET specific surface area of about 453.89; micropore area of about 416.69 m²/g).

The Barrett, Joyner, and Halenda (BJH) desorption average pore diameter of the example raw 3DG, the example acid-treated 3DG, and the example N-doped 3DG were determined to be about 2.64 nm, about 3.13 nm, and about 3.27 nm, respectively. The example raw 3DG exhibited an abundant number of micropores. While not wishing to be bound by any particular theory, the micropores may originate from in situ oxidization of graphene walls due to CO₂. Here, the decrease in surface area and pore volume with progressive functionalization of the 3DG confirms the successful grafting of functional groups on the 3DG surface similar to that observed for stepwise functionalization at the surface of mesoporous silica materials. A second reason may be agglomeration of graphene layers.

Raman spectroscopy was utilized to evaluate the example raw 3DG (Ex. 401), example acid-treated 3DG (Ex. 402), and example N-doped 3DG (Ex. 403) samples. Overlayed Raman spectra are shown in FIG. 4B.

As shown in FIG. 4B, the D band at about 1355 cm⁻¹ corresponds to the disordered sp2 carbon generated by linking with sp3 carbon atoms, and the G band at about 1575 cm 1 corresponds to the stretching of sp2 carbon pairs. The integrated intensity ratio (I_{D}/I_{G}) of the D band to the G band (which may be used as the degree of disorder) of the example raw 3DG, the example acid-treated 3DG, and the example N-doped 3DG were determined to be about 1.0, about 1.02, and about 1.03, respectively. A larger I_{D}/I_{G} value indicates that the graphite layer structure becomes more disordered. This result proves that acidic functional groups and/or N atoms (e.g., pyrrolic-N, quaternary-N, and/or pyridinic-N) have entered the structure of graphene.

Furthermore, FT-IR spectroscopy was utilized to investigate the bonding differences between the example raw 3DG (Ex. 401), the example acid-treated 3DG (Ex. 402), and the example N-doped 3DG (Ex. 403) samples. Overlayed FT-IR spectra are shown in FIG. 4C.

As shown in FIG. 4C, the FT-IR spectrum of the example raw 3DG (Ex. 401) shows some characteristic bands of surface-oxidized groups at about 1102 cm⁻¹ (C—O stretching vibrations). The peak located at about 1626 cm⁻¹ is ascribed to the skeletal vibration of graphitic domains (C═C). FT-IR analysis of the example acid-treated 3DG (Ex. 402) showed that there are two additional characteristic peaks at about 1239 cm⁻¹ and about 1726 cm⁻¹, corresponding to C—OH, and COOH groups, respectively, indicating that the acid treatment resulted in acidic functional group bonded to the surface of the 3DG framework.

For the example N-doped 3DG (Ex. 403), in addition to the abovementioned peaks, C—N stretching vibrations were observed at about 1540 cm⁻¹, indicating that the reaction with the nitrogen-containing molecule resulted in a basic functional group bonded to the surface of the 3DG framework. Overall, the FT-IR spectra indicated successful functionalizations of the 3DG at the 3DG surface.

XPS was utilized to measure the surface elemental composition of the example raw 3DG (Ex. 401), the example acid-treated 3DG (Ex. 402), and the example N-doped 3DG (Ex. 403) samples. Overlayed XPS survey spectra are shown in FIG. 4D.

Both the example raw 3DG (Ex. 401) and the example acid-treated 3DG (Ex. 402) displayed two features: at about 284.8 eV and at about 532.3 eV. These features may be the result of photoelectrons emitted from the C Is core level and the O 1s core level. In addition to these features, the example N-doped 3DG (Ex. 403) displayed a third feature at about 400 eV, consistent with photoelectrons emitted from the N 1s core shell, indicating that nitrogen had been doped in the 3DG when treated with urea.

The C Is feature and the N Is feature of the example N-doped 3DG (Ex. 403) were deconvoluted to quantify the relative proportion of C—C, C—O, and C—N functional groups. FIG. 4E shows the C 1s feature at about 284.8 eV deconvoluted into five peaks, corresponding to five different C-species, namely C—C species, C—N species, C—O species, C═O species, and C—COO⁻ species. FIG. 4F shows the N 1s feature at about 400 eV deconvoluted into three peaks, corresponding to three different basic N-species, namely pyrrolic-N species, quaternary-N species, and pyridinic-N species. Tabulated results of the C Is feature and the N Is feature of the example N-doped 3DG are shown in Table 2A and Table 2B.

TABLE 2A

| C 1s | Binding energy, eV | Relative contribution, % |
|---|---|---|
| C—C | 284.85 | 61.93 |
| C—N | 286.33 | 16.24 |
| C—O | 287.79 | 6.67 |
| C═O | 289.21 | 10.57 |
| C—COO⁻ | 291.33 | 4.58 |

TABLE 2B

| N 1s | Binding energy, eV | Relative contribution, % |
|---|---|---|
| pyrrolic-N | 399.9 | 49.76 |
| quaternary-N | 400.5 | 30.42 |
| pyridinic-N | 399.1 | 19.81 |

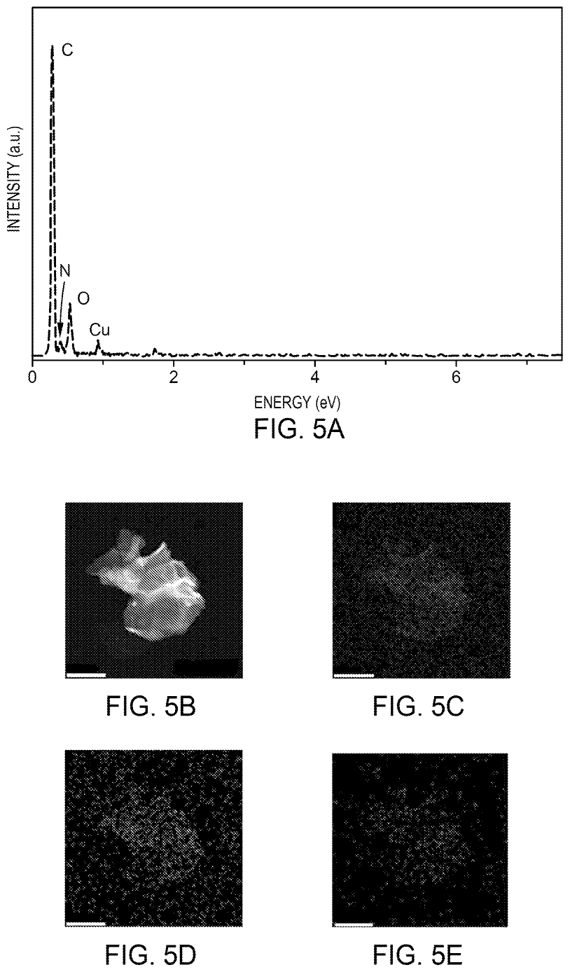

The elemental content (carbon (C), oxygen (O), and nitrogen (N)) of the example N-doped 3DG was analyzed using XEDS. FIG. 5A shows an XEDS spectrum of the example N-doped 3DG, and Table 3 shows selected results of the XEDS element analysis for the example N-doped 3DG.

TABLE 3

| Element | Weight % (wt %) | Atomic % |
|---|---|---|
| C | 89.17 | 91.63 |
| O | 10.74 | 8.29 |
| N | 0.09 | 0.08 |

The XEDS element analysis results indicated that the relative contents of carbon, oxygen, and nitrogen in the example N-doped 3DG were about 89.17 wt % (about 91.63 atomic %), about 10.74 wt % (about 82.9 atomic %), and about 0.09 wt % (about 0.08 atomic %), respectively.

High-angle annular dark-field (HAADF) imaging and XEDS mapping was performed on the example N-doped 3DG. The HAADF image of the example N-doped 3DG

High-angle annular dark-field (HAADF) imaging of N-doped 3DG (FIG. 5B) and XEDS mapping images showing the distribution of the carbon (FIG. 5C), oxygen (FIG. 5D), and nitrogen (FIG. 5E) of the example N-doped 3DG indicated that the whole surface of the graphene is uniformly doped with nitrogen. The XEDS results were determined to be consistent with the FT-IR and XPS results.

### Direct Air Capture (DAC) Analysis

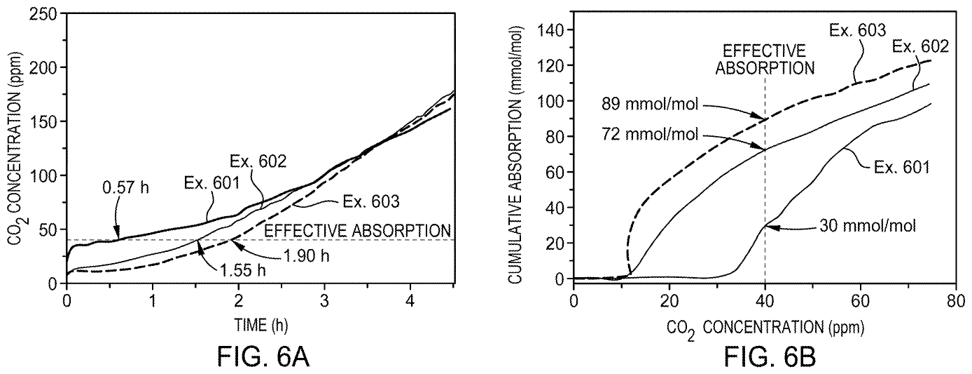

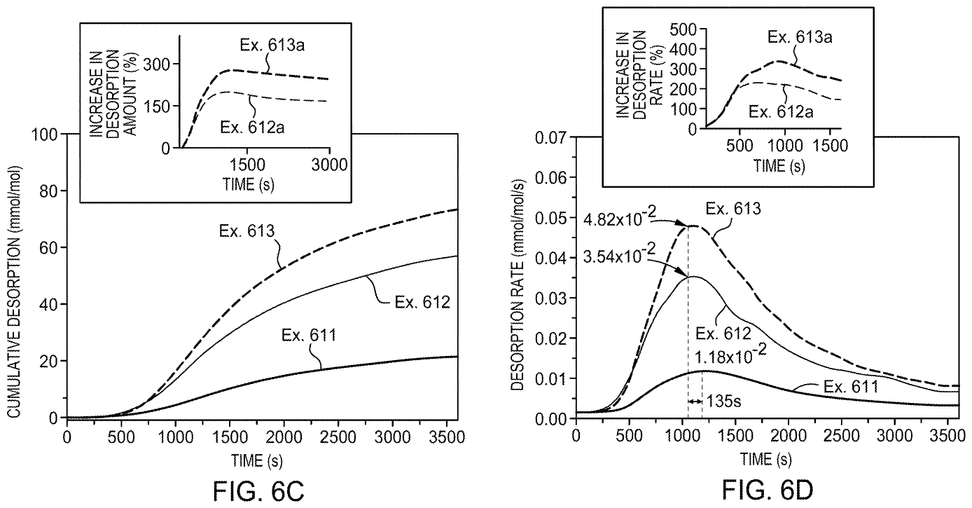

A lysine solution alone (Ex. 601) was investigated as a control. An example composition (Ex. 602) that included a lysine solution mixed with 500 ppm of an example raw 3DG catalyst and an example composition (Ex. 603) that included a lysine solution mixed with 500 ppm example N-doped 3DG were investigated. The lysine solution of the example compositions serves as a sorbent while the 3DG catalyst serves as a catalyst. Absorption results for various compositions are shown in FIGS. 6A and 6B and Table 4. The effective absorption times are from FIG. 6A and the cumulative CO₂ absorption (effective absorption capacity) data is from FIG. 6B.

TABLE 4

| | | Effective | Effective absorption |
|---|---|---|---|
| | | absorption | capacity, mmol CO₂/ |
| Sample | Catalyst | time, h | mol lysine |
| Ex. 601 (control) | — | 0.57 | 30 |
| Ex. 602 | Raw 3DG | 1.55 | 72 |
| Ex. 603 | N-doped 3DG | 1.90 | 83 |

Overall, the data shown in FIGS. 6A and 6B and Table 4 indicated that both of the example compositions (Ex. 602 and Ex. 603) significantly outperformed the control (Ex. 601). Ex. 603, that included the example N-doped 3DG catalyst displayed the longest effective absorption time (i.e., the time during which>90% CO₂ absorption was maintained), as well as the most CO₂ absorbed across the duration of the test. The effective absorption time and effective absorption capacity for the composition (Ex. 603) containing the example N-doped 3DG catalyst were determined to be about 1.90 hours and about 89 mmol CO₂/mol lysine, respectively, which are higher than the composition (Ex. 602) containing the example raw 3DG catalyst (about 1.55 hours; about 72 mmol CO₂/mol lysine) and the Ex. 601 without catalyst (0.57 hour; 30 mmol CO₂/mol lysine).

The enhanced results using the 3DG catalysts indicated that both 3DG catalysts can serve to catalyze absorption of CO₂. For example, use of the raw 3DG catalyst significantly increased the effective absorption time by about 172% and the working absorption capacity by about 140% relative to the control lysine solution. Use of the N-doped 3DG catalyst significantly increased the effective absorption time by about 233% and the working absorption capacity by about 197% relative to the control lysine solution. Overall, the data indicated that 3DG catalysts described herein catalyze absorption.

Desorption results for various compositions are shown in FIGS. 6C and 6D and Table 5. Cumulative CO₂ desorption is from FIG. 6C and the desorption rate is from FIG. 6D.

Desorption performance data are shown in FIGS. 6C and 6D. Ex. 611 refers to the CO₂-enriched lysine solution without catalyst (corresponding to spent Ex. 601), Ex. 612 refers to the CO₂-enriched composition with 500 ppm of the raw 3DG catalyst (corresponding to spent Ex. 602), and Ex. 613 refers to the CO₂-enriched composition with 500 ppm of N-doped 3DG catalyst (corresponding to spent Ex. 603). The catalytic CO₂ desorption performance of example raw 3DG catalyst and example N-doped 3DG catalyst were estimated with the lysine solution after the CO₂ effective absorption. The desorption was performed at a temperature of about 70° C.

TABLE 5

| | Cumulative desorption | Desorption rate, mmol |
|---|---|---|
| | after 1 hour, mmol CO₂/ | CO₂/mol lysine/ |
| Sample | mol lysine | second |
| Ex. 611 (control) | 22 | 1.18 × 10⁻² |
| Ex. 612 | 57 | 3.54 × 10⁻² |
| Ex. 613 | 74 | 4.82 × 10⁻² |

Overall, the data shown in FIGS. 6C and 6D and Table 5 indicated that the 3DG catalysts described herein catalyze CO₂ desorption.

As shown in FIG. 6C and Table 5, the cumulative desorption for the composition of Ex. 613 was determined to be about 74 mmol CO₂/mol lysine after about 1 hour. The cumulative desorption for the composition of Ex. 612 was determined to be about 57 mmol CO₂/mol lysine after about 1 hour. In contrast, the cumulative desorption for the control Ex. 611 was determined to be significantly lower at 22 mmol CO₂/mol lysine after 1 hour.

The inset in FIG. 6C shows the increase in cumulative desorbed CO₂ amount (mmol CO₂/mol lysine) from the CO₂-enriched compositions that included the lysine sorbent and a 3DG catalyst relative to the uncatalyzed spent control sample. As shown by Ex. 613a of the inset of FIG. 6C, the cumulative desorbed CO₂ amount of the catalyzed spent lysine solution with N-doped 3DG catalyst was determined to be about 280% greater than that of the spent uncatalyzed spent lysine solution at about 1,245 seconds. As shown by Ex. 612a of the inset of FIG. 6C, the cumulative desorbed CO₂ amount of the catalyzed spent lysine solution with the raw 3DG catalyst was determined to be about 200% greater than that of the spent uncatalyzed spent lysine solution at about 1,080 seconds.

FIG. 6D shows CO₂ desorption rates from the spent uncatalyzed sample (Ex. 611), the spent raw 3DG catalyzed sample, and the spent N-doped 3DG catalyzed sample (Ex. 613). The results shown in FIG. 6D and Table 5 indicated that the desorption rate for Ex. 611, Ex. 612, and Ex. 613 were 1.18×10⁻² mmol CO₂/mol lysine/s, about 3.54×10⁻² mmol CO₂/mol lysine/s, and about 4.82×10⁻² mmol CO₂/mol lysine/s, respectively, demonstrating a significant increase in desorption rate when using the 3DG catalysts.

As shown in the inset of FIG. 6D, addition of the example N-doped 3DG catalyst increased the CO₂ desorption rate by about 338% relative to that of the spent uncatalyzed lysine solution (Ex. 613a). Ex. 613 (having the N-doped 3DG catalyst) also achieved its maximum CO₂ desorption about 135 seconds earlier than the sample without catalyst. As shown by Ex. 612a of the inset of FIG. 6D, addition of the raw 3DG catalyst increased the CO₂ desorption rate by about 231% relative to that of the uncatalyzed lysine solution. The kinetic results of CO₂ desorption indicated that desorption of CO₂ from CO₂-enriched compositions containing 3DG catalysts significantly outperform those CO₂-enriched compositions without a 3DG catalyst, with the N-doped 3DG catalyst performing better than the raw 3DG catalyst.

### Temperature-Programmed Desorption (TPD) Analysis

TPD analysis was performed. TPD of carbon dioxide (CO₂-TPD) and TPD of ammonia (NH₃-TPD) were utilized to investigate the acid-base characteristics of the 3DG catalysts—example raw 3DG catalyst (Ex. 701), example acid-treated 3DG catalyst (Ex. 702), and example N-doped 3DG catalyst (Ex. 703). Acid and base characteristics are important for CO₂ capture.

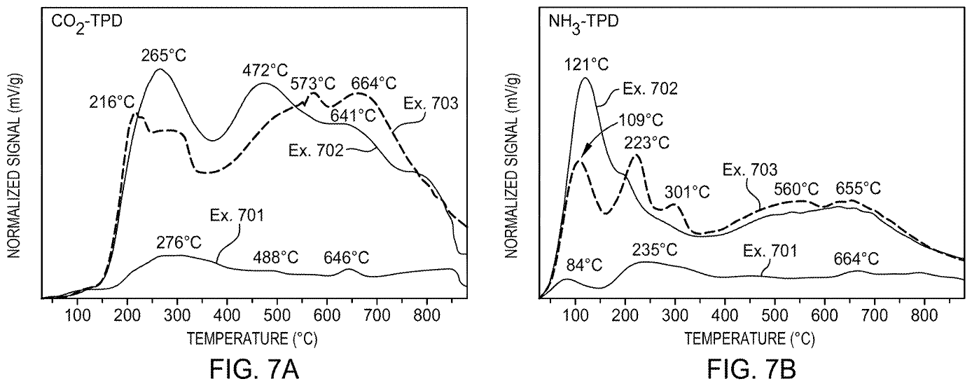

FIG. 7A shows the results for the CO₂-TPD profiles and FIG. 7B shows the results for NH₃-TPD profiles. In FIG. 7A, the desorption peaks were assigned as follows: the desorption peaks located at a temperature range from about 50° C. to about 200° C. were attributed to weak basic sites; the desorption peaks located at a temperature range from about 200° C. to about 400° C. were attributed to moderate basic sites; and the desorption peaks located at a temperature range from about 400° C. to about 900° C. were attributed to strong basic sites. At the weak and moderate base site, example acid-treated 3DG catalyst (Ex. 702) showed a larger number of acid-base sites than example raw 3DG catalyst (Ex. 701) and the example N-doped 3DG catalyst (Ex. 701). At the strong basic site, the desorbed amount of CO₂ was determined to follow the order: example N-doped 3DG catalyst (Ex. 703)>example acid-treated 3DG catalyst (Ex. 702)>example raw 3DG catalyst (Ex. 701).

In FIG. 7B, the desorption were assigned as follows: the desorption peaks located at a temperature range from about from about 50° C. to about 200° C. were assigned to weak acid sites; the desorption peaks located at a temperature range from about from about 200° C. to about 400° C. were assigned to moderate acid sites; and the desorption peaks located at a temperature range from about from about 400° C. to about 900° C. were assigned to strong acid sites. The corresponding desorbed NH₃ capacity are summarized in Table S2.

Among the three samples, the example acid-treated 3DG catalyst (Ex. 702) possessed the largest amount of weak acid sites, followed by example N-doped 3DG catalyst (Ex. 703) and the example raw 3DG catalyst (Ex. 701). At the moderate acid site, the desorbed amount of NH₃ was determined to follow the order: example N-doped 3DG catalyst (Ex. 703)>example acid-treated 3DG catalyst (Ex. 702)>example raw 3DG catalyst (Ex. 701).

The example N-doped 3DG catalyst (Ex. 703) and the example acid-treated 3DG catalyst (Ex. 702) possessed a large amount of strong acidity at the strong acid site, while example raw 3DG (Ex. 701) showed a small amount. Combining the two TPD profiles together, the prepared N-doped 3DG catalyst (Ex. 703) possesses both acid and basic sites. That is, the N-doped 3DG catalyst (Ex. 703) is an acid-base bifunctional catalyst. Both acid and base sites can be important in DAC.

Table 4A shows CO₂-TPD data for example as-synthesized 3DG catalysts. In Table 4A, the number of weak basic sites, medium basic sites, and strong basic sites was determined by the CO₂ desorption peak area of the various basic sites; “TBS” refers to the total CO₂ desorption peak area of the various basic sites; and basic sites density was determined by dividing TBS by the BET specific surface area of the 3DG catalyst (Basic site density=TBS/BET specific surface area).

TABLE 4A
CO₂-TPD data of as-synthesized example 3DG catalysts

| | Number | Number | Number | | |
|---|---|---|---|---|---|
| | of weak | of medium | of strong | | Basic |
| | basic | basic | basic | | site |
| Sample | sites | sites | sites | TBS | density |
| Unfunctionalized | 590 | 3,317 | 5,502 | 9,409 | 11.3 |
| 3DG | | | | | |
| Acid-treated 3DG | 1,730 | 16,777 | 33,882 | 52,389 | 89.7 |
| N-doped 3DG | 1,942 | 13,723 | 35,118 | 50,783 | 111.9 |

Table 4B shows NH₃-TPD data for example as-synthesized 3DG catalysts. In Table 4B, the number of weak acid sites, medium acid sites, and strong acid sites was determined by the NH₃ desorption peak area of the various acid sites; “TAS” refers to the total NH₃ desorption peak area of the various acid sites; and acid sites density was determined by dividing TAS by the BET specific surface area of the 3DG catalyst (Acid site density=TAS/BET specific surface area).

TABLE 4B
NH₃-TPD data of as-synthesized example 3DG catalysts

| | Number | Number | Number | | |
|---|---|---|---|---|---|
| | of weak | of medium | of strong | | Acid |
| | acid | acid | acid | | site |
| Sample | sites | sites | sites | TAS | density |
| Unfunctionalized | 3,194 | 8,183 | 15,141 | 26,518 | 31.9 |
| 3DG | | | | | |
| Acid-treated 3DG | 29,746 | 20,792 | 48,923 | 99,461 | 170.3 |
| N-doped 3DG | 19,890 | 24,669 | 52,545 | 97,104 | 213.9 |

### Cyclic Stability

The stability of the CO₂-capturing compositions was investigated. To test the stability of the composition that includes the lysine solution and the example N-doped 3DG catalyst, 50 cycles of absorption-desorption experiments were run.

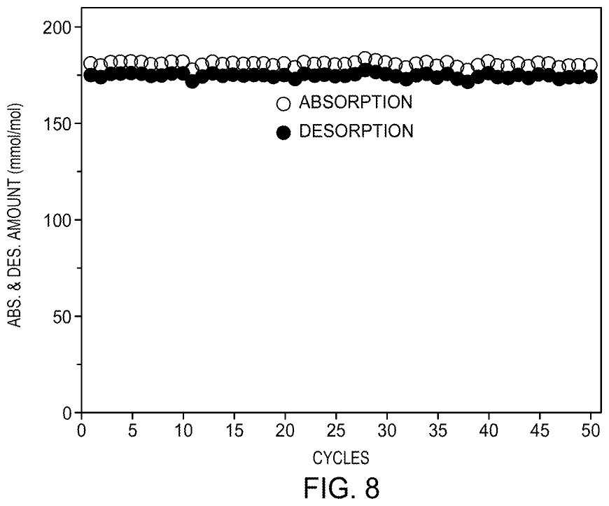

As shown in FIG. 8, the CO₂-capturing composition was determined to be stable over about 2 months and multiple experiments, with an average cumulative absorption amount of about 180.6 mmol CO₂/mol lysine, and average cumulative desorption amount of about 174.7 mmol CO₂/mol lysine, with no sign of deterioration in the absorption capacity after 50 cycles. The absorption capacity retention was determined to be about 98.7%. The results indicated that CO₂-capturing compositions described herein are very stable over many cycles and after long periods of time.

The development of a low-cost DAC composition (a CO₂-capturing composition) as described herein may be used for effective mitigation of climate change. CO₂-capturing compositions described herein that include an amino acid and a 3DG show good multi-reuse performance indicating that this composition may be cost-saving, resource-conserving, and environmentally friendly.

In some examples, it was shown that the use of only 500 ppm 3DG catalyst increases DAC breakthrough time (with >90% CO₂ absorption efficiency) by about 233% and working CO₂ absorption capacity by about 197%. Also, the 3DG catalyst significantly accelerates CO₂ desorption, for example, the desorption capacity and desorption rate increases by about 280% and about 338% at 70° C., respectively, which may allow regeneration of the DAC sorbent by using large amount of otherwise wasted widely available low-temperature heats. Regeneration temperatures of monoethanolamine (MEA)—a commercial CO₂ capture agent—is about 120° C. In contrast, 3DG catalyzed amino acid solutions described herein can be regenerated at significantly lower temperatures (e.g., about 70° C.). With this significantly lower temperature, a large amount of cheap industrial waste heat can be effectively utilized for the regeneration, greatly reducing the cost of DAC. Such cheap industrial waste heat could not be utilized for regenerating MEA and other conventional CO₂ capture agents.

In some examples, a 50-cycle DAC test indicated that both the sorbent and the catalyst of CO₂-capturing compositions described herein described herein are stable. The 3DG successfully improves the DAC absorption and desorption efficiency of amino acid sorbents, which is significantly beneficial to the development of next-generation DAC technologies.

Overall, 3DG catalysts with high micropore ratios were prepared by the CO₂-to-graphene conversion reaction. An unfunctionalized 3DG catalyst may be modified with concentrated nitric acid to produce an acid-treated 3DG catalyst and urea to produce an N-doped 3DG catalyst. The results indicated that CO₂-capturing compositions that include a 3DG catalyst described herein show significantly improved CO₂ absorption and desorption performance relative to uncatalyzed solutions. The results also demonstrate that amino acid solutions with a 3DG catalyst is a technically feasible and environmentally friendly DAC technology. In addition, embodiments of the present disclosure provide facile, efficient, and scalable results indicating that amino acids with 3DG catalysts significantly improve CO₂ absorption and desorption efficiencies relative to conventional technologies.

### Embodiments Listing

The present disclosure provides, among others, the following embodiments, each of which can be considered as optionally including any alternate embodiments:
Clause A1. A CO₂-capturing composition, comprising:
   an amino acid; and
   a three-dimensional graphene (3DG).
Clause A2. The CO₂-capturing composition of Clause A1, wherein the amino acid comprises alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, pyrrolysine, or combinations thereof.
Clause A3. The CO₂-capturing composition of Clause A1, wherein the amino acid comprises lysine, arginine, histidine, or combinations thereof.
Clause A4. The CO₂-capturing composition of any one of Clauses A1-A3, wherein the amino acid comprises lysine.
Clause A5. The CO₂-capturing composition of any one of Clauses A1-A4, wherein the 3DG comprises an unfunctionalized 3DG, an acid-treated 3DG, a nitrogen-doped 3DG, or combinations thereof.
Clause A6. The CO₂-capturing composition of Clause A5, wherein the nitrogen-doped 3DG comprises a basic nitrogen-containing functional group.
Clause A7. The CO₂-capturing composition of Clause A6, wherein the basic nitrogen-containing functional group comprises a pyrrole, a quaternary amine, a pyridine, or combinations thereof.
Clause A8. The CO₂-capturing composition of any one of Clauses A5-A7 comprises an acidic functional group.
Clause A9. The CO₂-capturing composition of any one of Clauses A1-A8, further comprising a solvent.
Clause A10. The CO₂-capturing composition of Clause A9, wherein the solvent comprises water.
Clause B1. A process for forming a CO₂-capturing composition, the process comprising:
   (a) heating a mixture comprising a three-dimensional graphene (3DG) and an acid to form an acid-treated 3DG; and
   (b) reacting a mixture comprising an acid-treated 3DG and a nitrogen-containing molecule to form a nitrogen-doped 3DG comprising a basic nitrogen-containing functional group.
Clause B2. The process of Clause B1, further comprising sonically or ultrasonically treating a mixture comprising an amino acid and the nitrogen-doped 3DG to form the CO₂-capturing composition.
Clause B3. The process of Clause B1 or Clause B2, wherein the heating the mixture comprising the three-dimensional graphene (3DG) and the acid to form the acid-treated 3DG of operation (a) is performed by:
   heating the mixture at a temperature that refluxes the mixture, or at a temperature that is from about 50° C. to about 130° C., or from about 70° C. to about 110° C., or from about 80° C. to about 100° C., or about 90° C.; and/or
   heating the mixture for a period that is from about 15 minutes to about 4 hours, or from about 30 minutes to about 4 hours, or from about 1 hour to about 3 hours, or about 2 hours.
Clause B4. The process of any one of Clauses B1-B3, wherein the acid comprises HNO₃, HCl, H₂SO₄, H₃PO₄, HBr, or combinations thereof.
Clause B5. The process of any one of Clauses B1-B4, wherein, after forming the acid-treated 3DG and before reacting the acid-treated 3DG with the nitrogen-containing molecule, the process further comprises:
   filtering (by, e.g., vacuum or gravity) the mixture comprising the acid-treated 3DG and the acid to collect solids;
   washing the collected solids with water until a pH value of neutral is achieved; and
   drying the solids at a temperature of about 50° C. to about 130° C., or from about 70° C. to about 110° C., or from about 80° C. to about 100° C., or about 90° C., and/or for a period of about 10 hours to about 48 hours, or from about 15 hours to about 36 hours, or from about 18 hours to about 30 hours, or about 24 hours.
Clause B6. The process of any one of Clauses B1-B5, wherein the reacting the mixture comprising the acid-treated 3DG and the nitrogen-containing molecule of operation (b) is performed with one or more of the following parameters:
   heating at a temperature that is from about 110° C. to about 210° C., or from about 130° C. to about 190° C., or from about 150° C. to about 170° C., or about 160° C.;
   heating for a period that is from about 1 hour to about 5 hours, or from about 2 hours to about 4 hours, or about 3 hours;
   the heating is performed in an autoclave;
   at a weight ratio of the acid-treated 3DG to the nitrogen-containing molecule that is from about 1:10 to about 1:50, or from about 1:20 to about 1:40, or about 1:30; or
   combinations thereof.
Clause B7. The process of any one of Clauses B1-B6, wherein the nitrogen-containing molecule comprises urea, melamine, thiourea, cyanamide, dicyandiamide, or combinations thereof.
Clause B8. The process of any one of Clauses B1-B7, after forming the nitrogen-doped 3DG, wherein the process further comprises:
   filtering (by, e.g., vacuum or gravity) the mixture comprising the nitrogen-doped 3DG and the nitrogen-containing molecule to collect solids;
   washing the collected solids with water until a pH value of neutral is achieved; and
   drying the solids at a temperature of about 50° C. to about 130° C., or from about 70° C. to about 110° C., or from about 80° C. to about 100° C., or about 90° C., and/or for a period of about 10 hours to about 48 hours, or from about 15 hours to about 36 hours, or from about 18 hours to about 30 hours, or about 24 hours.
Clause B9. The process of any one of Clauses B1-B8, wherein the unfunctionalized 3DG utilized to form the acid-treated 3DG in operation (a) is formed by CO₂-to-graphene conversion.
Clause B10. The process of Clause B9, wherein the CO₂-to-graphene conversion is performed by:
   setting a reactor having metal therein (e.g., Na metal) to a pressure that is from about 10 psi to about 90 psi, or from about 30 psi to about 70 psi, or from about 40 psi to about 60 psi, or about 50 psi while the reactor is placed at a first temperature that is from about 15° C. to about 25° C.;
   introducing CO₂ to the reactor having a metal therein while the reactor is set at the first pressure and first temperature; and
   forming the unfunctionalized 3DG by heating the reactor (with or without flow of the CO₂) at a second temperature that is from about 300° C. to about 900° C., or from about 400° C. to about 800° C., or from about 500° C. to about 700° C., or from about 450° C. to about 650° C., or about 600° C. for a period that is from about 10 hours to about 48 hours, or from about 15 hours to about 36 hours, or from about 18 hours to about 30 hours, or about 24 hours.
Clause B11. The process of Clause B10, wherein after forming the unfunctionalized 3DG, the process further comprises:
   separating the unfunctionalized 3DG from by-products by washing with water; and/or
   drying the separated unfunctionalized 3DG.
Clause C1. A process for capturing CO₂ from a gas or gaseous stream, the process comprising:
   introducing a CO₂-containing gas or CO₂-containing gaseous stream with a CO₂-capturing composition, the CO₂-capturing composition comprising:
      an amino acid;
      a 3DG; and
      optionally a solvent (e.g., water).
Clause C2. The process of Clause C1, wherein the CO₂-capturing composition prior to the introducing the CO₂-containing gas or CO₂-containing gaseous stream has a first concentration of CO₂, and the CO₂-capturing composition after the introducing the CO₂-containing gas or CO₂-containing gaseous stream has a second concentration of CO₂ that is greater than the first concentration of CO₂.
Clause C3. The process of Clause C1 or Clause C2, wherein the 3DG comprises an unfunctionalized (raw) 3DG, an acid-treated 3DG, a N-doped 3DG, or combinations thereof.
Clause C4. The process of any one of Clauses C1-C3, wherein the CO₂-containing gas or CO₂-containing gaseous stream comprises from about 1 ppm to about 10,000 ppm CO₂, such as about 1,000 ppm or less CO₂.
Clause C5. The process of any one of Clauses C1-C4, wherein the CO₂-containing gas or CO₂-containing gaseous stream comprises about 500 ppm or less CO₂.
Clause C6. The process of any one of Clauses C1-C5, wherein the CO₂-containing gas or CO₂-containing gaseous stream comprises about 400 ppm or less CO₂.
Clause C7. The process of any one of Clauses C1-C6, wherein at least a portion of the CO₂-capturing composition is ultrasonically pretreated prior to introducing the CO₂-containing gas or CO₂-containing gaseous stream with the CO₂-capturing composition.
Clause C8. The process of any one of Clauses C1-C7, wherein the CO₂-capturing composition comprises the CO₂-capturing composition of any one of Clauses A1-A10.
Clause D1. A process for desorption of CO₂, the process comprising:
   heating a CO₂-capturing composition having a first concentration of CO₂ to form a CO₂-capturing composition having a second concentration of CO₂ that is lower than the first concentration of the CO₂, the CO₂-capturing composition comprising:
      an amino acid;
      a three-dimensional graphene (3DG); and
      optionally a solvent (e.g., water).
Clause D2. The process of Clause D1, wherein the 3DG comprises an unfunctionalized (raw) 3DG, an acid-treated 3DG, a N-doped 3DG, or combinations thereof.
Clause D3. The process of Clause D1 or Clause D2, wherein the heating the CO₂-capturing composition is performed at a heating temperature that is from about 25° C. to about 95° C. at about 1 atm.
Clause D4. The process of any one of Clauses D1-D3, wherein the heating temperature is from about 60° C. to about 80° C.
Clause D5. The process of any one of Clauses D1-D4, wherein the CO₂-capturing composition comprises the CO₂-capturing composition of any one of Clauses A1-A10.
Clause E1. A process, comprising:
   contacting a CO₂-containing gas or CO₂-containing gaseous stream with a CO₂-capturing composition comprising an amino acid, a 3DG, and optionally a solvent (e.g., water) in an absorption unit to form a CO₂-capturing composition having a first concentration of CO₂;
   heating at least a portion of the CO₂-capturing composition having the first concentration of CO₂ in a desorption unit;
   separating CO₂ from the CO₂-capturing composition having the first concentration of CO₂ to form a CO₂-capturing composition having a second concentration of CO₂.
Clause E2. The process of Clause E1, further comprising:
   regenerating the CO₂-capturing composition from at least a portion of the CO₂-capturing composition having the second concentration of CO₂, recycling at least a portion of the CO₂-capturing composition having the second concentration of CO₂ to the absorption unit, or both.
Clause E3. The process of Clause E1 or Clause E2, wherein the 3DG comprises an unfunctionalized (raw) 3DG, an acid-treated 3DG, a N-doped 3DG, or combinations thereof.
Clause E4. The process of any one of Clauses E1-E3, wherein the absorption unit and the desorption unit are the same unit.
Clause E5. The process of any one of Clauses E1-E4, wherein the CO₂-containing gas or CO₂-containing gaseous stream comprises from about 1 ppm to about 10,000 ppm CO₂.
Clause E6. The process of any one of Clauses E1-E5, wherein the CO₂-containing gas or CO₂-containing gaseous stream comprises about 1,000 ppm or less CO₂, such as about 400 ppm or less CO₂. Clause D5. The process of any one of Clauses E1-E6, wherein the CO₂-capturing composition comprises the CO₂-capturing composition of any one of Clauses A1-A10.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method, or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the foregoing aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, embodiments comprising “an amino acid” include embodiments comprising one, two, or more amino acids, unless specified to the contrary or the context clearly indicates only one amino acid is included.

Certain molecules disclosed herein may contain one or more ionizable groups [groups from which a proton may be removed (e.g., —COOH) or added (e.g., amines) or which may be quaternized (e.g., amines)]. All possible ionic forms of such molecules and salts thereof are intended to be included individually in the disclosure herein.

While the foregoing is directed to embodiments of the present disclosure, other and further embodiments of the disclosure may be devised without departing from the basic scope thereof, and the scope thereof is determined by the claims that follow.

What is claimed is:

1. A CO₂-capturing composition, comprising:
an amino acid; and
a three-dimensional graphene (3DG).

2. The CO₂-capturing composition of claim 1, wherein the amino acid comprises alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, pyrrolysine, or combinations thereof.

3. The CO₂-capturing composition of claim 1, wherein the amino acid comprises lysine, arginine, histidine, or combinations thereof.

4. The CO₂-capturing composition of claim 1, wherein the amino acid comprises lysine.

5. The CO₂-capturing composition of claim 1, wherein the 3DG comprises an unfunctionalized 3DG, an acid-treated 3DG, a nitrogen-doped 3DG, or combinations thereof.

6. The CO₂-capturing composition of claim 5, wherein the nitrogen-doped 3DG comprises a basic nitrogen-containing functional group.

7. The CO₂-capturing composition of claim 6, wherein the basic nitrogen-containing functional group comprises a pyrrole, a quaternary amine, a pyridine, or combinations thereof.

8. The CO₂-capturing composition of claim 5, wherein:
the acid-treated 3DG comprises an acidic functional group;
the nitrogen-doped 3DG comprises an acidic functional group and a basic nitrogen-containing functional group; or
combinations thereof.

9. The CO₂-capturing composition of claim 1, further comprising water.

10. A process for forming a CO₂-capturing composition, the process comprising:
heating a mixture comprising an unfunctionalized three-dimensional graphene (3DG) and an acid to form an acid-treated 3DG;
reacting the acid-treated 3DG with a nitrogen-containing molecule to form a nitrogen-doped 3DG comprising a basic nitrogen-containing functional group; and
sonically or ultrasonically treating a mixture comprising an amino acid and the nitrogen-doped 3DG to form the CO₂-capturing composition.

11. A process for capturing CO₂ from a gas or gaseous stream, the process comprising:
introducing a CO₂-containing gas or CO₂-containing gaseous stream with a CO₂-capturing composition comprising:
an amino acid;
a three-dimensional graphene (3DG); and
optionally water.

12. The process of claim 11, wherein the 3DG comprises an unfunctionalized 3DG, an acid-treated 3DG, a N-doped 3DG, or combinations thereof.

13. The process of claim 11, wherein the CO₂-containing gas or CO₂-containing gaseous stream comprises from about 1 ppm to about 10,000 ppm CO₂.

14. The process of claim 11, wherein the CO₂-containing gas or CO₂-containing gaseous stream comprises from about 1 ppm to about 1,000 ppm CO₂.

15. The process of claim 11, wherein the CO₂-containing gas or CO₂-containing gaseous stream comprises about 400 ppm or less CO₂.

16. The process of claim 11, wherein at least a portion of the CO₂-capturing composition is ultrasonically pretreated prior to introducing the CO₂-containing gas or CO₂-containing gaseous stream with the CO₂-capturing composition.

17. A process, comprising:
contacting a CO₂-containing gas or CO₂-containing gaseous stream with a CO₂-capturing composition comprising an amino acid and a three-dimensional graphene (3DG) in an absorption unit to form a CO₂-capturing composition having a first concentration of CO₂;
heating at least a portion of the CO₂-capturing composition having the first concentration of CO₂ in a desorption unit; and
separating CO₂ from the CO₂-capturing composition having the first concentration of CO₂ to form a CO₂-capturing composition having a second concentration of CO₂ that is lower than the first concentration of CO₂.

18. The process of claim 17, wherein the 3DG comprises an unfunctionalized 3DG, an acid-treated 3DG, a N-doped 3DG, or combinations thereof.

19. The process of claim 17, wherein the absorption unit and the desorption unit are the same unit.

20. The process of claim 17, wherein:
the CO₂-containing gas or CO₂-containing gaseous stream comprises from about 1 ppm to about 10,000 ppm CO₂;
the heating the at least a portion of the CO₂-capturing composition having the first concentration of CO₂ is performed at a temperature that is from about 50° C. to about 95° C.; or
combinations thereof.
